(19) United States
(12) Patent Application Publication
(10) Pub. No.: US 2013/0019189 A1
(43) Pub. Date: Jan. 17, 2013

(54) AUGMENTED EDITING OF AN ONLINE DOCUMENT

(71) Applicants: Shawn J. Stewart, Plantation, FL (US); Senta McAdoo, Tamarac, FL (US)

(72) Inventors: Shawn J. Stewart, Plantation, FL (US); Senta McAdoo, Tamarac, FL (US)

(73) Assignee: CBS INTERACTIVE INC, San Francisco, CA (US)

(21) Appl. No.: 13/182,865

(22) Filed: Jul. 14, 2011

(51) Int. Cl. G06F 3/01

(52) U.S. Cl. 715/760

(57) ABSTRACT

An apparatus is disclosed that comprises a processor and memory coupled to the processor. The memory is operable to store an augmented website editor. The augmented website editor may be operable to edit one or more objects of a web page copy of a web page and to link the one or more objects to respective data sources associated with the web page.

### BACKGROUND

Development, maintaining, and updating online documents or network documents is often a collaborative effort, especially in organizations in which multiple individuals may be responsible for editing and/or creating the online documents. In many organizations, online documents, such as websites and individual web pages may be assembled from heterogeneous platforms because of the variety of content and sources of content that are employed to build and maintain a website. In many cases, the backend of a website may be built using a different platform than that used for building the front end. This may make editing of web pages a cumbersome experience.

In particular, during development of websites, the website designers and programmers may use a variety of products to build the structure of a website and a different set of tools to assist in maintenance and modification of content within the context of the structure. For example, building the front end structure of a website can be accomplished by using Cascading Style Sheets (CSS), a style sheet language that describes the presentation of a document written in a markup language. One typical application of CSS is to style web pages written in Hypertext Markup Language (HTML) and Extensible Hypertext Markup Language (XHTML). The CSS can also be applied to various kinds of Extensible Markup Language (XML) documents, including Scalable Vector Graphics (SVG) and XML User Interface Language (XUL). Generating or modifying a web page that includes complex functionality can involve the use of multiple applications to prepare the necessary coding, including extensive modification of the back end. In many instances, knowledge of coding languages and/or other specialized applications or protocols can be necessary to competently prepare a web page. Additionally, typically available web page generation tools are typically executed at a local machine to prepare the code necessary to implement a web page. This code is then uploaded to a server to implement the web page for access over a network. When modifications to the web page are required, the coding is modified and a new version is uploaded.

Moreover, in managing websites over an enterprise, a conglomeration of unrelated tools may be employed to manage different elements of the sites. Many of the tools are written in different programming languages, have a different look and feel from one another, and are distributed differently across the organization. In some organizations different functional groups may operate separately in which web tools used for preparation, maintenance, and editing of websites may differ. It is therefore often challenging for site developers to update and modify existing websites in a convenient fashion.

On the front end, it is often desirable to view the web page being worked on in a format that closely matches the appearance of the web page as published. Various editing schemes have been developed to perform what is often referred to as in-line editing. In-line editors may include a variety of schemes in which one degree or another of WYSIWYG (“What You See Is What You Get”) editing may be performed to assemble a website. In such editors source code of documents is not directly edited, but rather the presentation as it (hopefully) will appear in the final document. Instead of writing blocks of code manually, a user may manipulate a web page with design components using an editor window. The hoped for result is the ability to view something similar to a end result while a document or image is being created. However, this is not always possible to edit and view the appearance of the web page as it will be published because components are not accessible to the user for direct editing.

It is with respect to these and other considerations that the present improvements have been needed.

### BRIEF DESCRIPTION OF THE DRAWINGS

FIG. 1 depicts an augmented website editing system in accordance with an embodiment.

FIG. 2 depicts another embodiment of an augmented website editing system.

FIG. 3a depicts one example of a downloaded web page.

FIG. 3b depicts one example of a web page copy.

FIG. 3c depicts another example of a web page copy.

FIG. 3d depicts another example of a web page copy.

FIG. 4a depicts an exemplary display arrangement provided by an augmented website editor.

FIG. 4b depicts another exemplary display arrangement provided by an augmented website editor.

FIG. 5a depict exemplary features of an augmented website editor.

FIG. 5b depict exemplary features of another augmented website editor.

FIG. 6a depicts exemplary aspects of a method according to some embodiments.

FIG. 6b depicts exemplary aspects of another method according to further embodiments.

FIG. 6c depicts exemplary aspects of a method according to additional embodiments.

FIGS. 7a and 7b depict one illustration of navigating a display provided by an augmented website editor.

FIG. 8a depicts objects of a web page at a first instance.

FIG. 8b depicts the objects of FIG. 8a at a second instance.

FIG. 8c depicts the objects of FIG. 8a after editing.

FIG. 9 illustrates an embodiment of an exemplary computing architecture.

FIG. 10 illustrates a block diagram of an exemplary communications architecture.

### DETAILED DESCRIPTION

Various embodiments are generally directed to systems and architecture for flexible creation and editing of online documents. Such online documents may be accessible to multiple users to manage and edit. Particular examples online documents include documents accessible through a network, such as web pages and websites. In various embodiments, an augmented website editing system (“AWE system”) is provided that facilitates updating and publishing of a given web page or website by multiple users independently of one another. Unless otherwise specified, as used herein, the term “web page” may generally also denote a website, which is a collection of related web pages. In various embodiments, during creation or editing of web content by a user, the AWE system may provide a visual display of how the Web content appears within a web page or website being updated or created. The user may thus be apprised in real time of how the content editing affects the appearance of the component being edited as well as other components of a web page.

In some embodiments, an AWE system may include an augmented website editor that is configured to interface with a data translation layer. The augmented website editor may act as a universal editor that interfaces with the data translation layer to facilitate in-line editing and publishing of web pages. In other embodiments, an augmented website editor may include the data translation layer. The AWE systems of the present embodiments may include software and hardware used to control a dynamic collection of Web material, such as documents, images, and other forms of media. The AWE system embodiments disclosed herein thereby facilitate document control, editing, and other functions. In some embodiments, an AWE system may facilitate collaborative construction and editing of Web content, for example, allowing content to be retrieved and worked on by one or many authorized users. Changes can be tracked and authorized for publication or ignored reverting to old versions.

AWE systems such as those described herein may be implemented in conjunction with various combinations of software used to construct and maintain websites, including, but not limited to, the Linux operating system, Apache Web server software, MySQL database management system or database server, PHP or other programming languages including but not limited to Perl and Python. Other combinations are also possible.

Website development, maintenance, and updating may often involve multiple users who wish to control visual content of the website. In some embodiments, an AWE system provides the ability for one or more users to directly edit a website, including images, text, and other content. In accordance with various embodiments, the AWE system translates a visual representation of a website into a data representation of the website. In particular, a map may be created which maps a presentation back to a data source. The data source may be, among other things, a database, a set of document databases, or a data file. In various embodiments, the data source may be accessed through a network, a local socket connect, or a web service.

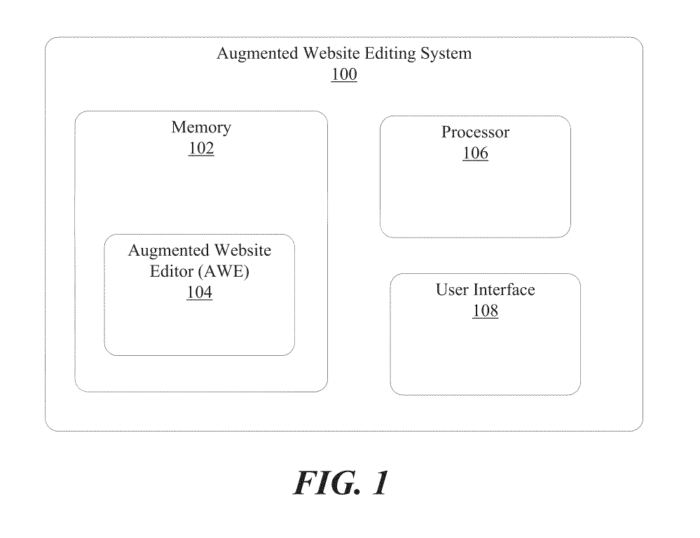

FIG. 1 depicts an augmented website editing system 100 that includes a memory 102, processor 106 and user interface 108. The memory 102 may include an augmented website editor (AWE) 104 whose operation and structure is detailed below. In various embodiments, the memory 102, processor 106, and user interface may be distributed in one or more hardware components including Web servers, client computers, and the like. In some embodiments the AWE 104 may be distributed within one or more memories 102.

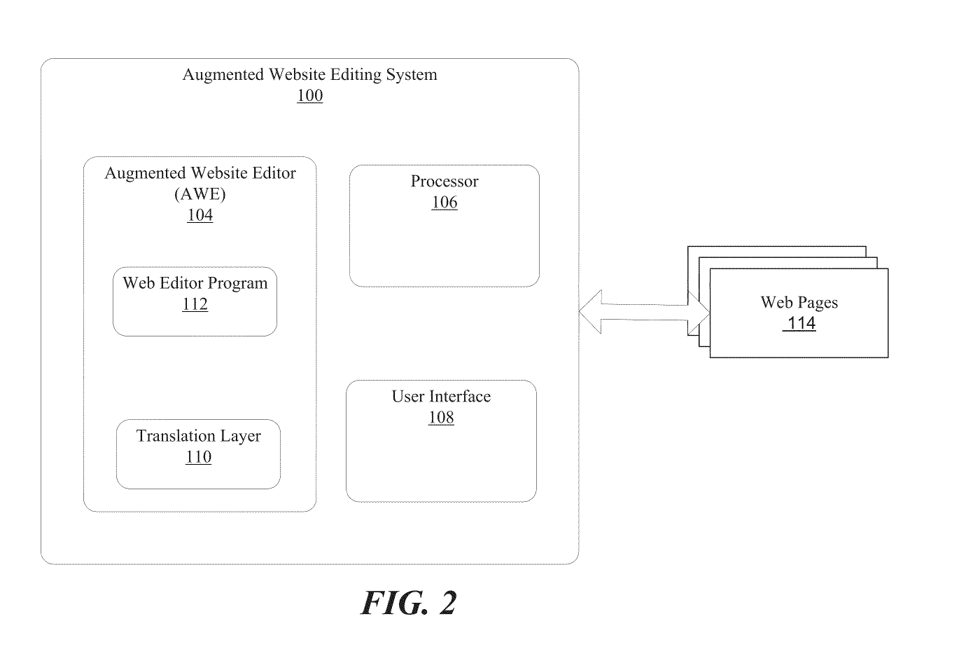

FIG. 2 depicts an embodiment of AWE system 100 in which the AWE 104 includes a translation layer 110 and a Web editor program 112. In some embodiments, the AWE system 100 may be operable to retrieve one or more web pages 114, which may be web pages that are stored within one or more external Web servers (not shown) and may be accessible to external users including the general public. In various embodiments, the AWE 104 may be loaded within a client (user) device (not shown) and may be configured to retrieve and display a web page 114 on the user device. The user device may be any device that provides or is linked to a visual display of web page 114 and may provide other capabilities such as audio and video functions.

In order to provide capability for editing of web pages 114, augmented website editor 104 may include one or more Web editor programs 112. In various embodiments, these may include any convenient text editor for creating and editing text, and may include additional editors for editing non-text objects. Some examples of programs that may be used include JavaScript, which is an object-oriented scripting language, and jQuery, which is a cross-browser JavaScript library designed to assist client-side scripting of HTML.

When a user wishes to edit a given web page 114, the user may link to that web page, for example, by entering a locator for that web page. In some implementations, the AWE 104 may incorporate, be linked to or be integrated into a web browser. The AWE may be operable to download a copy of the desired web page(s) 114 into AWE system 100.

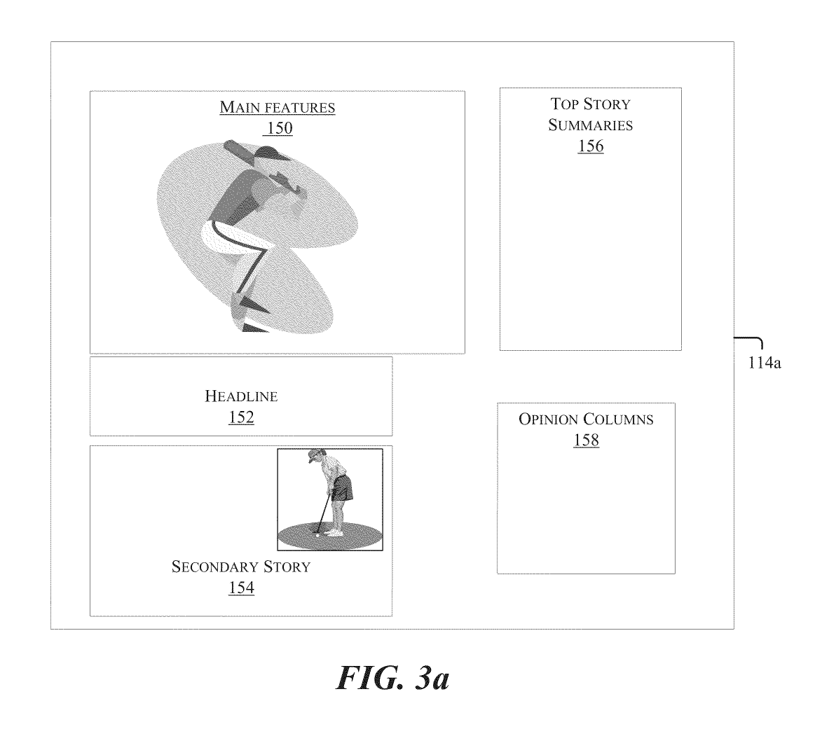

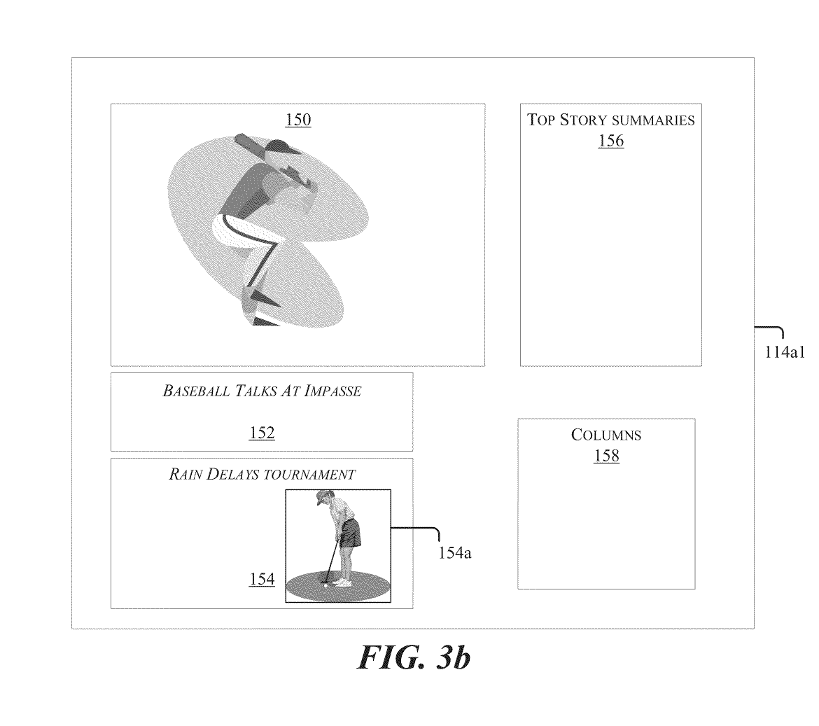

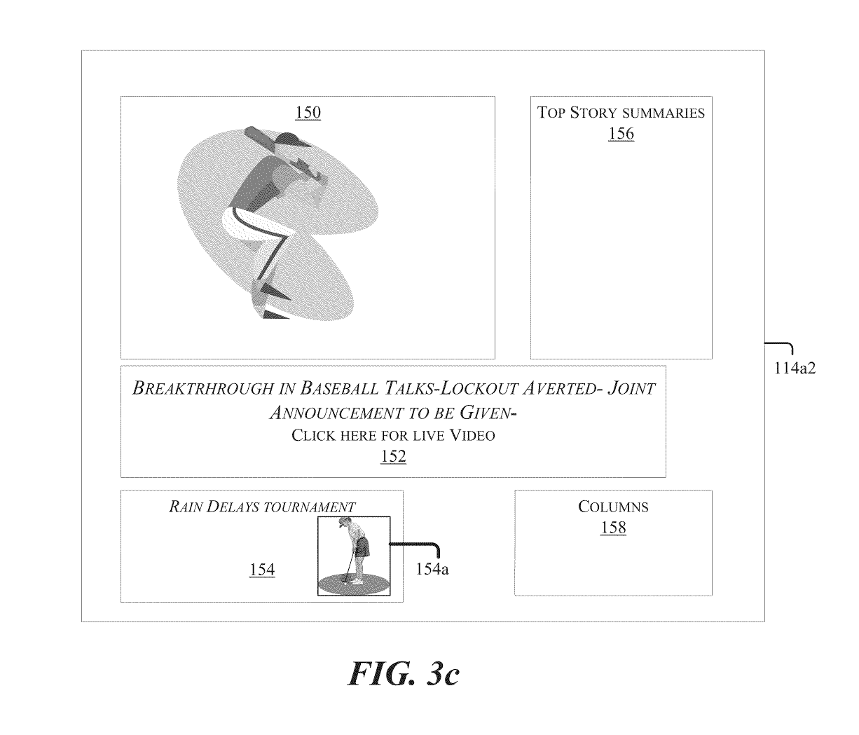

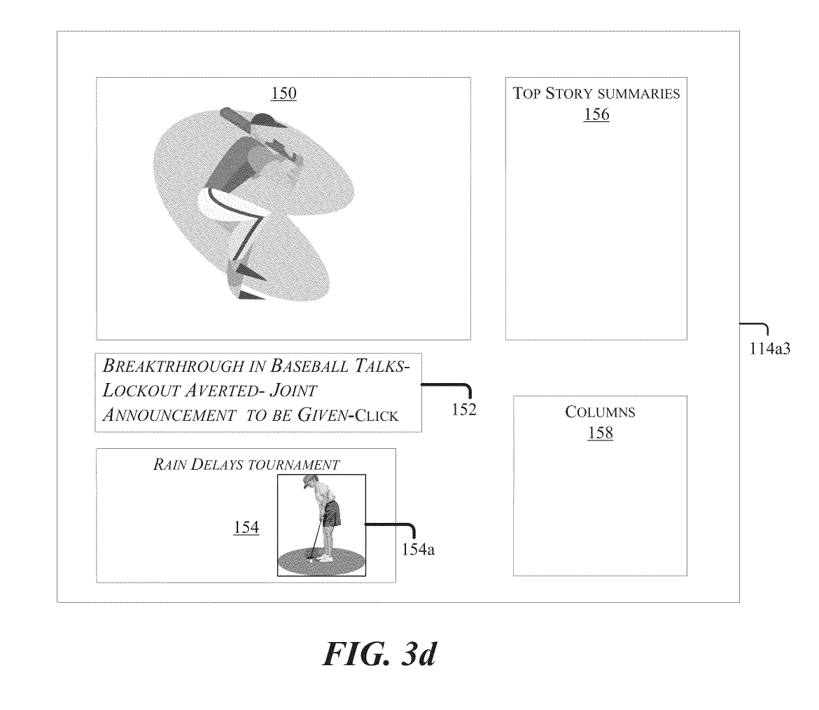

Once a copy of a web page 114 is downloaded, the AWE 104 may operate to edit the downloaded copy based upon user input, which may be received through user interface 108. In various embodiments, the AWE 104 may employ the editor program(s) 112 and translation layer 110 to edit and (re)publish a downloaded web page 114. FIG. 3a depicts one example of a downloaded web page copy 114a, which may be provided on any convenient display. In the example illustrated, the web page copy 114a has multiple objects (fields), including “Main feature” object 150, “Headline” object 152, “Secondary story” object 154, “Top story summaries” object 156, and “Columns” object 158. As used herein, the term “object” refers to a component of a web page, including an image, video file, text field, composite field, or other component that is presented to a user in the web page. In various embodiments, one or more of objects 150-158 may be directly editable by the AWE 104, such that the content and/or form of the objects is changed by AWE 104. It is to be noted that editing of an object 150-158 may entail editing of one or more files that are associated with that object, such as the files used to create and define that object.

FIG. 3b depicts one example of a web page copy in which the web page copy 114a1 depicts the form and content of a web page 114a at a first instance. The web page copy 114a1 may represent the current web page 114a as viewable by internet users who may browse the web page using an appropriate browser that links a user client device (not shown) to a web server containing the web page 114a. The “Main feature” object 150 may include an image, such as a picture file and may contain other features, such as tabs (not shown) that link to other fields or web pages. The “Secondary story” object 154 may also include an image 154a. As depicted in FIG. 3b, the “Headline” object 152 includes the text “BASEBALL TALKS AT IMPASSE” and the “Secondary story” object 154 includes the text “RAIN DELAYS TOURNAMENT.” As such, the web page 114a1 may represent the current web page as accessible on public Web servers.

FIG. 3c depicts another instance of a web page copy in which the web page copy 114a2 may be an edited version of the web page copy 114a1. In particular, the web page copy 114a2 includes an updated “Headline” object 152, which includes a main headline that reads “BREAKTHROUGH IN BASEBALL TALKS-LOCKOUT AVERTED-JOINT ANNOUNCEMENT TO BE GIVEN” and a secondary headline: “CLICK HERE FOR LIVE VIDEO,” which may provide a link to further content. The web page copy 114a2 may be created by a user who wishes to update the content and/or form of a web page or a website, and may wish to include updated information in one or more objects that are provided in the web page 114a.

The web page copy 114a2 provides a convenient means for a user to assess how updating objects in the web page 114a may affect the appearance, information, and ease of use of the web page 114a, among other factors. For example, the size of “Headline” object 152 is larger in web page copy 114a2 that in web page copy 114a1. Furthermore, the size of “Secondary story” object 154 and “Columns” object 158 is less than that of the corresponding objects in web page copy 114a1. The altering of object sizes may be accomplished in some instances through use of a program or programs that are operable to format a web page containing multiple objects, which may include various programs known to those of skill in the art. In particular, in the example of FIG. 3c, the “Secondary story” object 154 is significantly reduced in size including image 154a. Moreover, in some cases the maximum object size for “Headline” object 152 may be fixed so that the addition of text may not fit into the allotted field area, as illustrated in FIG. 3d. The text field size of the “Headline” object 152 in FIG. 3d may have a maximum size as shown. Accordingly, the full text that a user may enter into a text file for “Headline” object 152 (see FIG. 3c) may not be visible in the web page copy 114a3. Accordingly, the ability to view web page copies, such as 114a2 and 114a3 may assist the user in rapidly assessing whether proposed edits to a web page are acceptable.

In accordance with various embodiments, if the user deems that the content and overall appearance and/or function of an edited web page, such as web page copy 114a2 is acceptable, the user may decide to publish the updated web page copy 114a2. As used herein, the term “publish” refers to placing a web page on a device, such as a publically accessible Web server in a manner that renders the web page accessible to public users. The “public” users may be users of the Internet, an organization intranet, or extranet, for example. Thus, publishing the web page may involve updating a pre-existing public web page with the edited web page copy in some instances. In this case, one or more Web servers are updated with the new web page copy 114a2, which may replace a previous web page 114a, whose content and appearance was as shown in web page copy 114a1.

In various embodiments, the augmented website editor 104 may be accessible to multiple users through multiple different devices, such that any of the multiple users may perform editing of web pages 114. In some embodiments, multiple users may view and edit a web page 114a at the same, although publishing of a given edited web page copy may be controlled according to a predetermined protocol.

Referring again to FIGS. 1 and 2, the AWE system 100 may also include a translation layer 110, which may provide a mapping of select objects of a website or web page. The translation layer 110 may in some embodiments be part of AWE 104 or may be located elsewhere in a memory 102, for example. The translation layer may provide an indication to AWE 104 as to the location of select data sources that correspond to the select objects of the website. In this manner, when a user loads a portion of a website, such as a web page, into AWE 104, the translation layer 110 may provide a mapping of the select objects that associates the select objects with select data sources that may be stored in a remote Web server, for example. This facilitates updating the data sources associated with one or more objects of a web page after a user has uploaded and edited that web page. Turning to the aforementioned exemplary web page 114a of FIGS. 3a-3d, one or more of the objects 150-158 may be associated with a corresponding data source, such as a database or data file (not shown) through the translation layer 110. For example, translation layer 110 may include a mapping of the “Headline” object 152 to a remote data source that is stored in a remote Web server (not shown). When the user completes editing of the “Headline” object 152 as depicted in FIG. 3c, translation layer 110 may serve to locate and update the data source associated with “Headline” object 152. The same may be possible for other objects 150, and 154-158. In this manner, the one or more associated data sources, which may be in XML format in some embodiments, may be edited by a user via AWE 104 regardless of the programs used to structure the front end of the web pages 114.

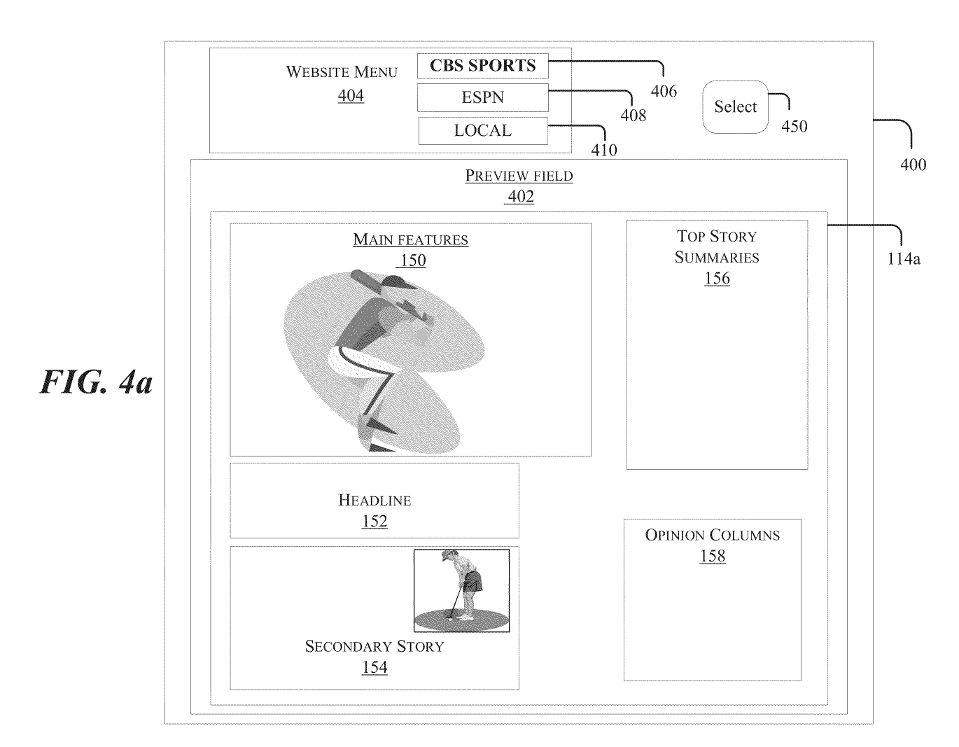

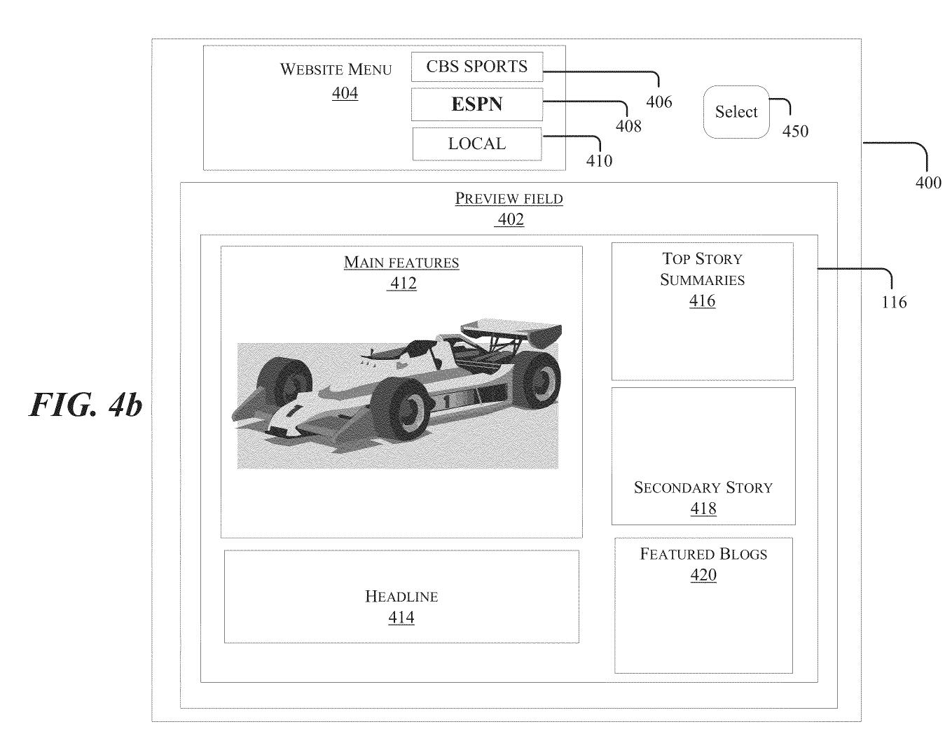

In some embodiments, an augmented website editor may provide the ability to load and edit web pages from multiple different websites. In particular embodiments, the AWE 104 may provide a user interface that allows a user to select and load different websites into a display for convenient editing of the websites. FIG. 4a depicts an exemplary display arrangement provided by an augmented website editor in which a display 400 includes a preview field 402 and a second field that is arranged as a website menu 404. The website menu 404 provides a user interface having multiple selections 406, 408, 410 that allows a user to select and load web page copies into preview field 402. Each loaded web page copy corresponds to a selection from website menu 404. The different selections 406, 408, 410 may correspond to different websites as illustrated. The selections 406-410 may be, for example, web page copies obtained from current public websites that may be downloaded onto a user device (not shown) coupled to the display 400. Loading of a selection into preview field 402 may be accomplished by various means, including via a scrollable menu, using a soft key such as a selection button 450, or any convenient selection means. The preview field 402 may display the currently selected web page, such as web page 114a, or web page 116, as depicted in FIGS. 4a and 4b, respectively. Upon selection of menu item 406, for example, the web page 114a is loaded into preview field 402. The web page 114a may be loaded in editable form, such that one or more objects 150-158 may be edited, as discussed above with respect to FIGS. 3a-3c. Similarly, upon selection of menu item 408, the web page copy 116 may be loaded into preview field 402. As depicted, the web page copy 116 has a different appearance than the web page copy 114a, since the web page copy 116 corresponds to a different website, which, in addition to having different content, may be formatted differently than the website from which web page copy 114a is obtained.

In particular, web page copy 116 includes a “Main Features” object 412, “Headline” object 414, “Top Stories Summary” object 416, “Secondary Story” object 418, and “Featured Blogs” object 420. Similarly to web page copy 114a, one or more objects 412-420 may be editable using an augmented website editor 104. In particular, files associated with each edited object may be saved and used to update a corresponding data source that is linked to a server from which the web page copy 116 is obtained.

As illustrated in FIGS. 4a and 4b, the website menu 404 may include further selections, including a “Local” selection 410, which, after being selected, may load a previously unpublished web page into preview field 402 for editing.

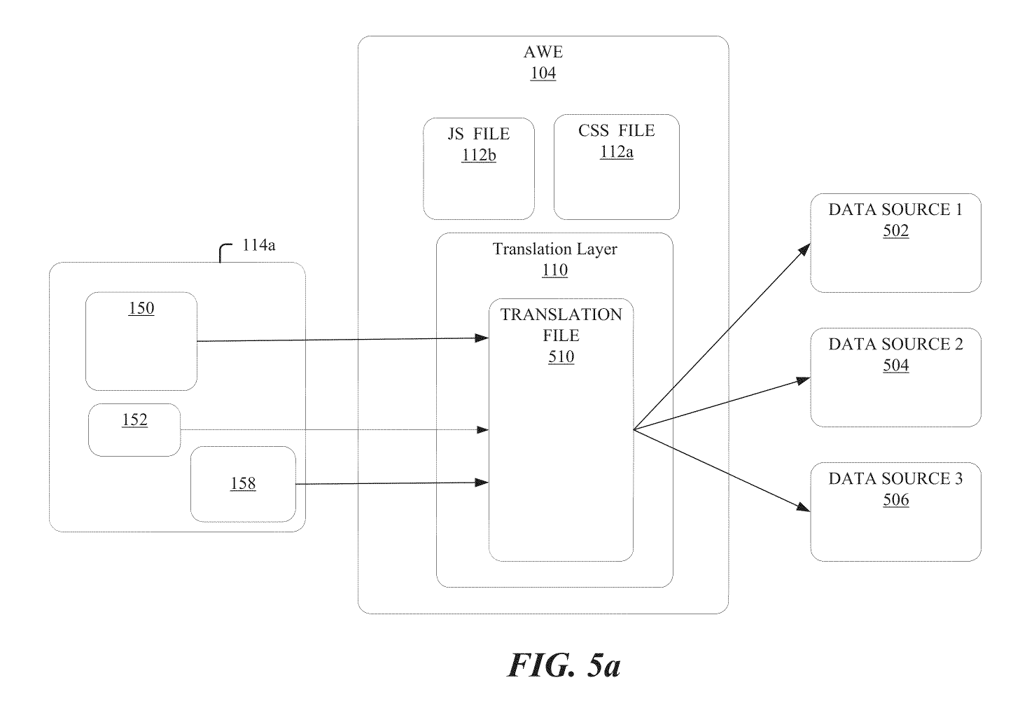

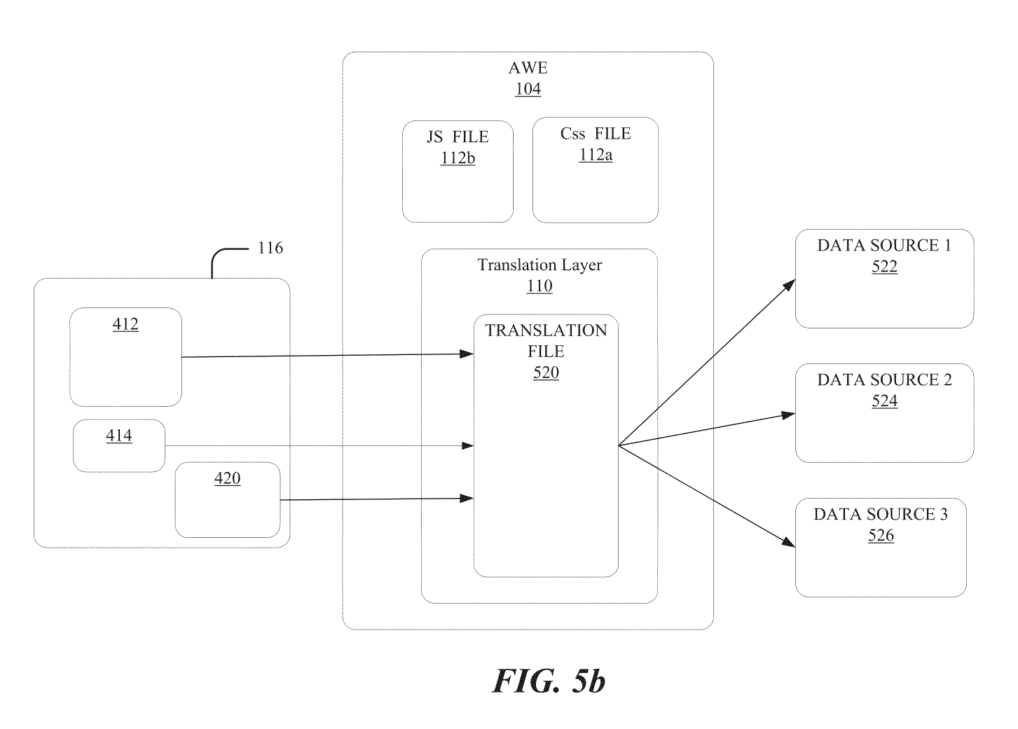

FIGS. 5a, 5b depict exemplary features of an AWE 104 that illustrate the mapping of editable objects of a web page to data sources. The AWE 104 includes program files 112, which may be files of known filetypes, such as a JavaScript (JS) file 112a and cascading style sheet (CSS) file 112b. The files may be used to format content and appearance of objects 150, 152, and 158 for display in web page 114a. The AWE 104 further includes a translation file 510 within translation layer 110. The translation file 510 may be of various formats. In some embodiments, the translation file 510 may include pointers that link the augmented website editor 104 to external data sources from which the content, function, and/or appearance of objects of the web page 114a are constructed. In some embodiments, the translation file 510 is an HTML file that includes links to external data sources 502, 504, and 506, which may correspond to objects 150, 152, and 158, respectively. Each link may be a combination of an anchor element that creates a hyperlink in translation file 510 together with an attribute that sets the uniform resource locator (URL) for the target data source 502-506.

Thus, when user input is received at a user interface to update an object, such as “Headline” object 152, the translation file 510 may direct the received user input to the external data file 504 when the edited web page copy 114a is ready for publishing. In various embodiments the data sources 502-506 may be created by any appropriate program. Similarly, updated “Main Feature” object 150 may be mapped to data source 502, and the “Columns” object 158 may be mapped to data source 506. The data sources 502-506 may be data files or databases that are used by external Web servers to construct the current public web page version of web page copy 114a. Thus, when a user of AWE 104 completes editing of web page copy 114a, the translation file 510 directs the updated information for objects 150, 152, and 158 to the appropriate data sources 502, 504, 506, thereby updating the current web page 114a.

As depicted in FIG. 5b, translation layer 110 may also include a translation file 520 that operates to map objects from web page 116 to corresponding data sources. In the example shown, “Main feature” object 412 may correspond to data source 522, “Headline” object 414 may correspond to data source 524, and “Featured Blog” object 520 may correspond to data source 526.

In various embodiments, translation files may be prestored in AWE 104 or alternatively, different translation files may be loaded into AWE 104 at the time that a corresponding website, such as a web page copy, is to be edited.

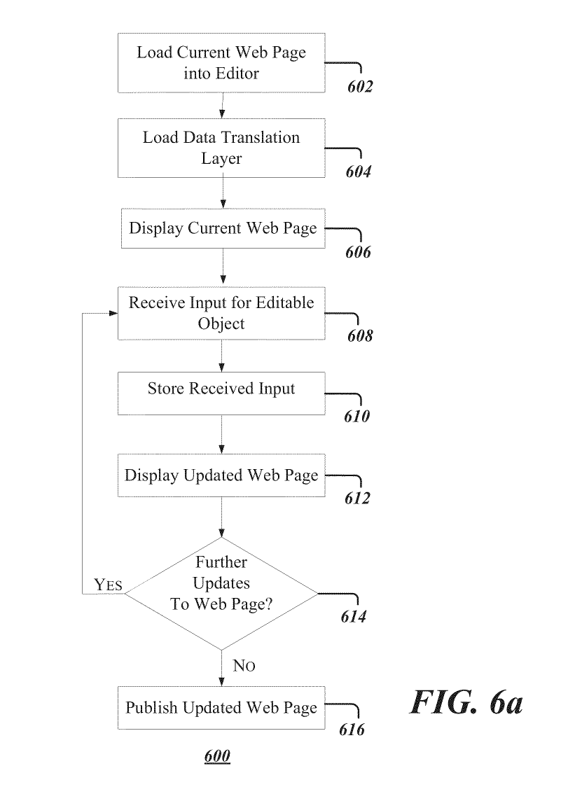

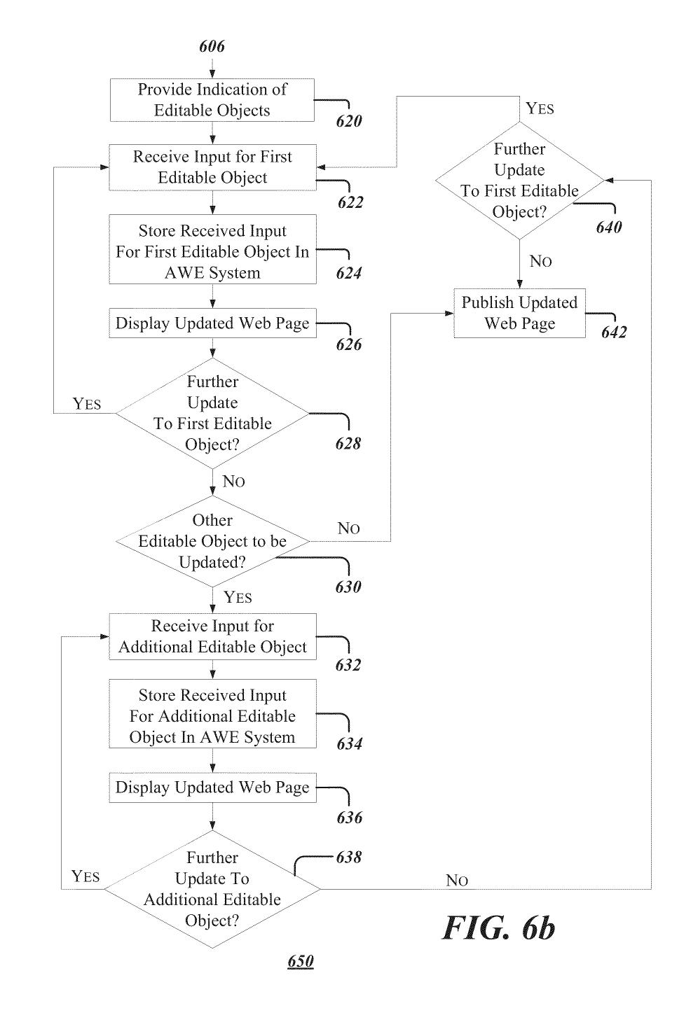

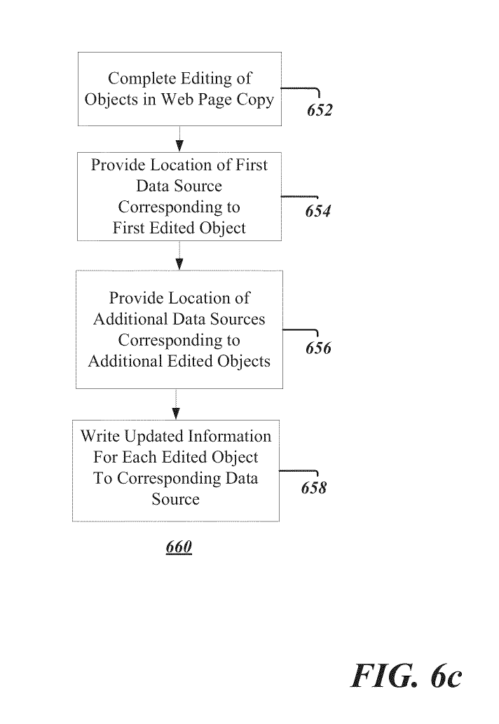

FIG. 6a depicts exemplary aspects of a method 600 according to further embodiments. At block 602, a current web page is loaded into an augmented website editor. The web page may be obtained as a copy of a current web page from a public website and copied into a memory associated with the augmented website editor. At block 604, a data translation file is loaded into the augmented website editor. In some implementations, the data translation file may provide a mapping capability for the current web page loaded at block 602. The mapping may include indicators that provide to the augmented website editor a location of a set of specific data sources that are associated with respective objects of the current web page. In some implementations, one or more data translation files corresponding to one or more web pages (or websites) may be loaded into the augmented website editor before a specific current web page is loaded.

At block 606, the current web page (copy) is displayed. For example, a copy of the web page may be loaded into a preview field provided by the augmented website editor on a display. The preview field may be arranged to display the current web page substantially similarly to the way in which the current web page may appear to users who access the website through a public server using a given browser. The current web page to be displayed may be selected from multiple loaded web pages.

At block 608, input is received for an editable object contained in the current web page. For example, a user may select to edit an object such as a “Headline” object of a web page that is displayed within a preview field, as illustrated in FIGS. 4a, 4b. Once an object is selected, an editable text field may be provided to the user to receive input to edit that object. The user may then edit the editable text field by using any convenient means, such as a keypad linked to the display providing the editable text field.

At block 610 the input for the editable object is stored. The input may include new or edited text that may change the amount of text, the size or appearance of a text field, for example. At block 612, an updated web page is displayed. The updated web page may be displayed as a web page copy in the preview field provided by the augmented website editor. At block 614, the updated web page may be evaluated by a user to determine if further changes are to be made. Notably, the appearance of one or more objects of the updated web page may be altered by the received input for the editable object. For example, the format or text of an object may be altered. In particular, due to size constraints, a text-based object, such as a “Headline” object, may not display all of the desired text entered into the text field for that object after updating. Accordingly, it may be desirable to re-edit the editable object to change the text content in order to conform to the size constraints of the object within the web page. Moreover, a user may desire to edit other objects within the web page. If, at block 614, further updates to the web page are desired, the method returns to block 608, where further input for editable object(s) is received. On the other hand, if no further updates are to be entered in the web page, the method proceeds to block 616, where the updated web page is published.

FIG. 6b depicts exemplary features of another method 650 according to further embodiments. In the method 650 the block 620 may occur after block 606 of method 600. Thus, after a web page is displayed to a user, an indication is provided as to what objects in the web page are editable. As noted above, in accordance with embodiments of an augmented website editor, a website copy may include certain objects that are editable, while other objects are not editable. It may be desirable, for example, to restrict the ability to edit certain objects, such as specific image or video files that are embedded in a web page. Accordingly, specific objects may be uneditable by users of the augmented website editor.

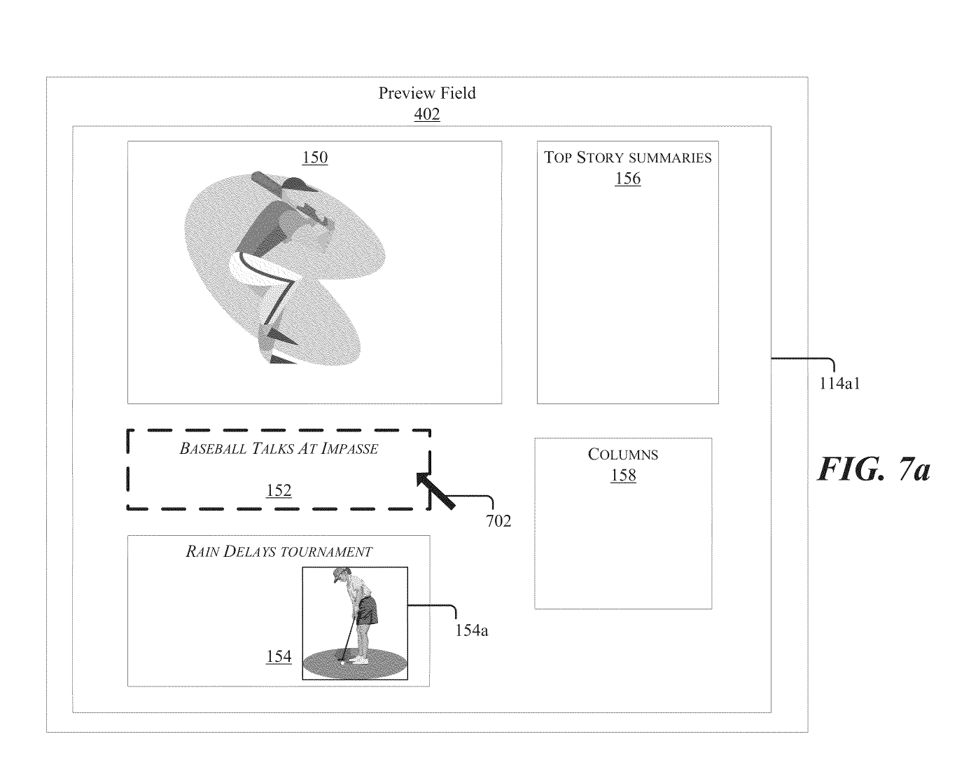

A user may be apprised as to whether an object in a web page is editable in various ways. For example, each editable object may change appearance when an indicating device is placed over the object. FIGS. 7a and 7b depict one example in which an indicating device is dragged over objects of a web page copy 114a that is displayed within preview field 402. In the example shown the indicating device is an electronic cursor 702, but may be any device, such as a user's finger in the case of a touch screen display. In FIG. 7a, when the cursor 702 is placed over “Headline” object 152, the border changes in appearance, indicating that the “Headline” object 152 is editable. In contrast, as illustrated in FIG. 7b, when the cursor 702 is placed over the “Columns” object 158, the appearance does not change, indicating that the “Columns” object 158 is not editable by the augmented website editor.

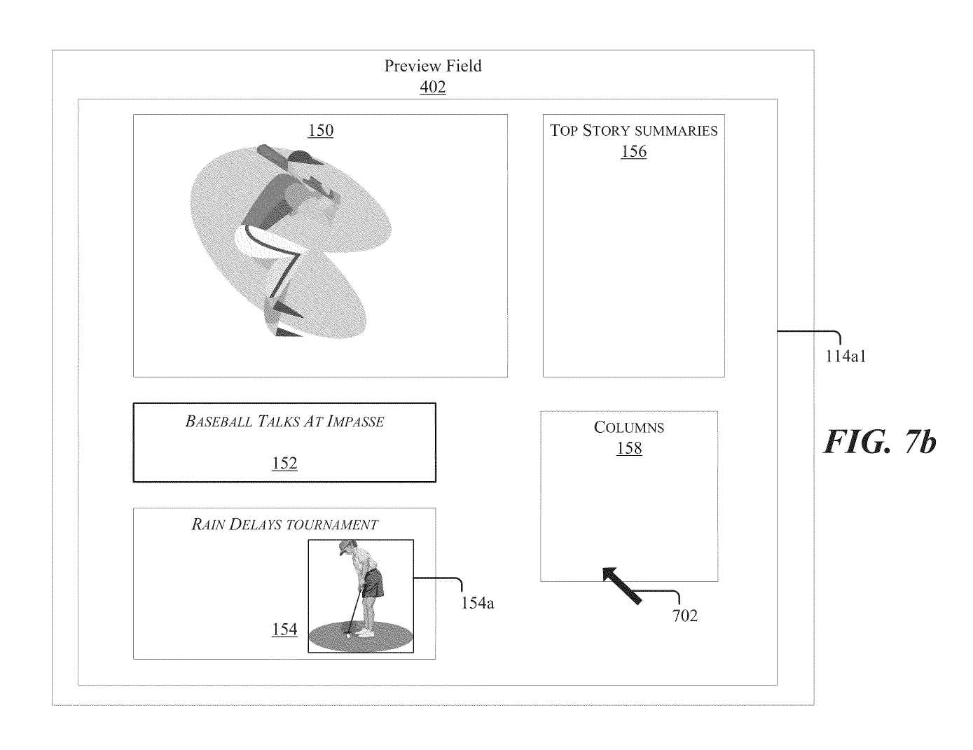

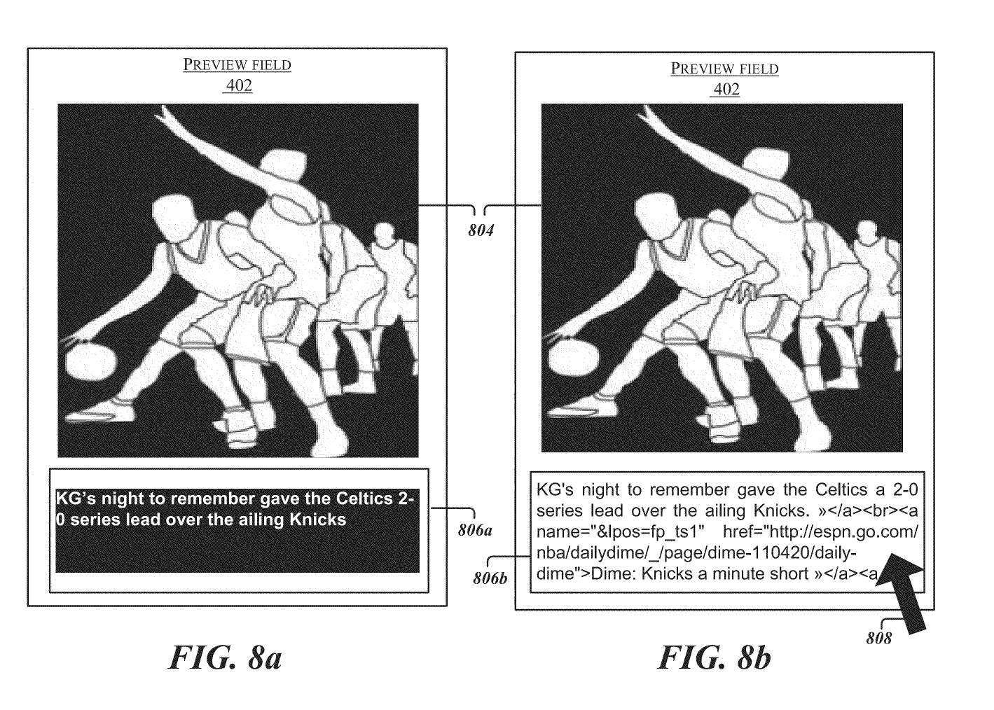

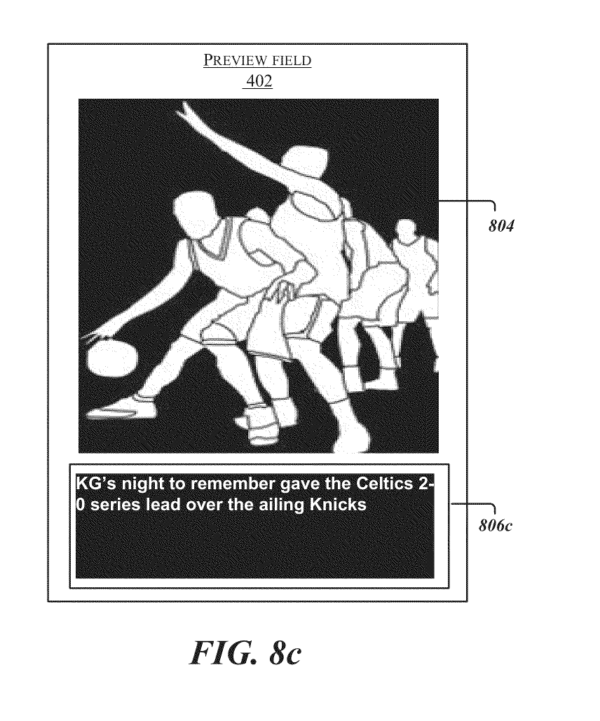

FIGS. 8a and 8b illustrate an example in which the appearance of text in a “Headline” field (object) 806 changes when a cursor is placed over the “Headline” object 806. In the example illustrated, the preview field 402 contains “Main feature” object 804 that is situated above the “Headline” object 806. The “Main feature” object 804 and “Headline” object 806 may be part of a web page copy, which may contain other objects that are not shown for clarity of illustration. However, more generally, the preview field 402 need not simultaneously display all other objects of a web page copy, which other objects may be accessed by scrolling, for example. As shown in FIG. 8a, the unhighlighted “Headline” object 806a provides a text summary, which may include text portions that are hyperlinks (not indicated) to other web pages. As illustrated in FIG. 8b, when a cursor 808 is placed over the “Headline” object, the “Headline” object 806b changes in both appearance and text content, providing an indication that the “Headline” object 806 is editable. In this case, the “Headline” object 806b includes HTML formatting language, which may be edited by use of input devices, such as a mouse and keypad.

At block 622, input is received for a first editable object. Once the first editable object is selected, the object may be edited as discussed above. If, for example, an editable text field for a “Headline” object is provided, the editable text field may be edited using a mouse and keypad linked to the display that displays the editable text field.

At block 624, the input for the first editable object is stored in an AWE system. For example, a local web page copy reflecting the updated “Headline” object may be saved on a device used to edit the local web page copy. At block 626, the updated web page is displayed to the user. For example, turning again to the example of FIG. 8, after editing of an HTML text field that appears when a cursor is placed over the “Headline” object 806, the cursor may be removed, in which case the edited “Headline” object 806c is displayed to the user, as depicted in FIG. 8c. In this case, the edited text no longer displays the HTML formatting visible when the cursor 808 is placed over “Headline” object 806. At block 628, if a further update to the first editable object is desired, the method returns to block 622. For example, the field size of edited “Headline” object 806c may be deemed to be too large. On the other hand, if no further changes are desired for the first editable object, the method proceeds to block 630.

At block 630, if another editable object is to be updated, the method moves to block 632 where input is received for the additional editable object. In some embodiments, the additional editable object may also be identified to the user as described above with respect FIGS. 7 and 8. The user may, for example, survey all the editable objects that are provided on a web page copy and determine which, if any, additional editable objects are to receive input to update the given object. If no other editable objects are to be updated, the method proceeds to block 642, where the updated web page is published. At block 634, the input received for the additional editable object is stored. At block 636, the updated web page reflecting changes to the additional editable object is displayed. At block 638, if further updates are desired for the additional editable object, the method returns to block 632 where further input for an additional editable object is received.

If no further updates are to be performed for the additional editable object, the method proceeds to block 640. At block 640 a determination is made as to whether the first editable object is to be updated. This may be desirable since changes to one object in a web page may cause changes in other objects or may cause the overall appearance of the web page to be altered such that it is desirable to alter the other objects. If further changes are to be made to the first editable object, the method returns to block 622. If not, the method proceeds to block 642, where the web page is published.

As will be apparent, the method 650 may be performed in any number of iterations in which changes are made to multiple objects in a web page copy before it is deemed ready to publish. An advantage provided by the AWE systems of the present embodiments is that the actual environment in which the objects will be published is presented to the user while the content is being edited. Therefore, the navigation through multiple iterations of changes to multiple objects within a web page is much less cumbersome since the web page appearance in published form may be continually viewed while changes are being made to the web page.

FIG. 6c depicts aspects of publishing a web page according to another exemplary method 660. At block 652, the editing of editable objects in a web page copy is completed, as described, for example, with respect to the methods 600 and 650 discussed previously. At block 654, the location is provided for a first data source that corresponds to the first edited object in the web page copy. The data source may correspond to a data source used to create the public web page (website) that corresponds to the edited web page copy. The data source may in general be located at any convenient place, and its location may be specified in a translation file of the augmented website editor that is used to edit the web page copy, as described above with respect to FIG. 5. If any additional objects are edited in the web page copy, the locations of additional data sources corresponding to those additional objects are provided at block 656. At block 658, the updated information for each edited object in the web page copy is written to a respective data source for each object. In one example, a user may determine that the edited web page copy is in condition for publishing. The user may then invoke a command or set of commands provided in a user interface by the AWE system. The command may operate to send from a local device the stored edited files that correspond to the edited objects of the web page copy to respective remote data sources. The remote data sources may then be updated to reflect the content of the stored edited files from the local device.

Although embodiments disclosed hereinabove depicted objects involving manipulation of text-based files, other embodiments in which images or video objects are edited and published to a web page are possible. Moreover, the present embodiments are operable with programming languages that provide additional capabilities beyond those provided by HTML, CSS, and JS, for example.

In various embodiments, the AWE systems disclosed herein may be deployed among multiple users at multiple locations. For example, multiple users may each download a current web page copy of a given web page to be edited. Before publishing the edited web page, input from each of the multiple users may be included in updating one or more objects of a web page copy. In one instance, multiple users may be provided in real time with a display of the same web page copy so that each user can view the web page copy as it is being edited.

In further embodiments, an augmented website editor may provide overlay analytics, including heat map information for objects being edited. This may be useful to modify or redesign a web page to maximize public user interaction with the web page, for example. In still other embodiments, an augmented website editor may provide tool tips and additional menu options for objects being edited.

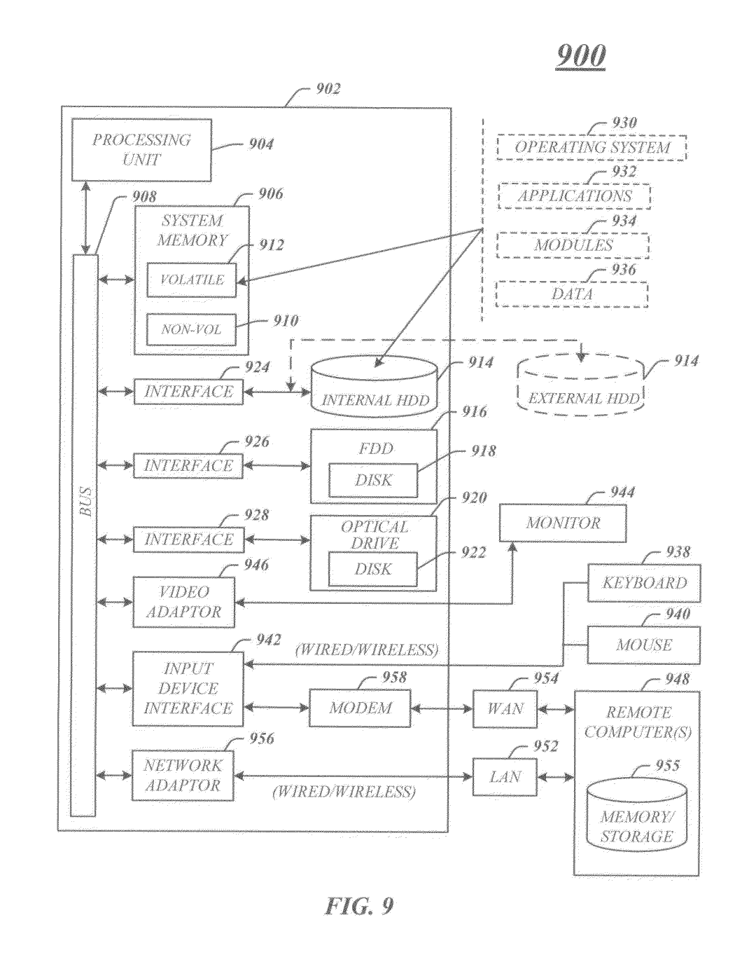

FIG. 9 illustrates an embodiment of an exemplary computing architecture 900 suitable for implementing various embodiments of the augmented website editor as previously described. In particular, the computing architecture 900 may be used by one or more users of the augmented website editor. The computing architecture 900 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors. Dual microprocessors and other multi-processor architectures may also be employed as the processing unit 904. The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures.

The system memory 906 may include various types of memory units to store information in system 100 and may be, for example, read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computer 902 may include various types of computer-readable storage media, including an internal hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936 applicable to system 100. The one or more application programs 932, other program modules 934, and program data 936 can include, for example, the AWE 104.

A user of AWE 104 may enter information into the computer 902 through one or more wire/wireless input devices, for example, a keyboard 938 and a pointing device, such as a mouse 940. Other input devices may include a microphone, an infra-red (IR) remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946 and can be used to display a downloaded web page, such as in a preview field. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a server computer, but may also be a workstation, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

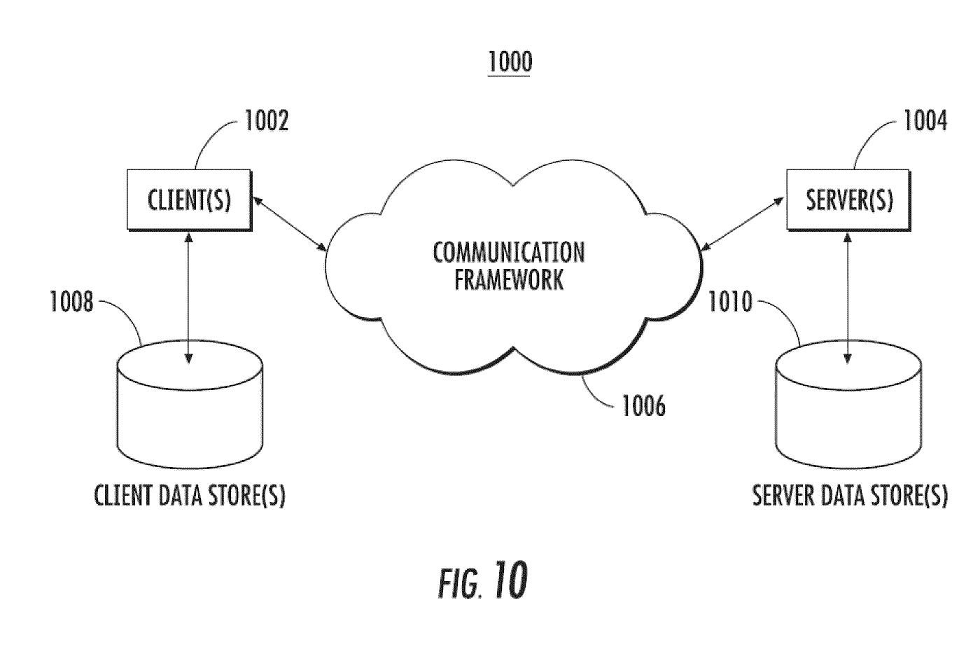

FIG. 10 illustrates a block diagram of an exemplary communications architecture 1000 suitable for implementing various embodiments of an augmented website editing system and methods as previously described. The communications architecture 1000 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 10, the communications architecture 1000 comprises one or more clients 1002 and servers 1004. The clients 1002 may implement website editing of a web page that is downloaded from the servers 1004. The clients 1002 and the servers 1004 are operatively connected to one or more respective client data stores 1008 and server data stores 1010 that can be employed to store information local to the respective clients 1002 and servers 1004, such as cookies and/or associated contextual information.

The clients 1002 and the servers 1004 may communicate information between each other using a communication framework 1006. The communications framework 1006 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 1002 and the servers 1004 may include various types of standard communication elements designed to be interoperable with the communications framework 1006, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 1002 and a server 1004 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments of the AWE system 100 and associated methods may comprise an article of manufacture. An article of manufacture may comprise a storage medium to store logic. Examples of a storage medium may include one or more types of non-transitory computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor; and
a memory communicatively coupled to the processor, the memory including an augmented website editor, the augmented website editor operable to:
edit one or more objects of a web page copy of a web page; and
link the one or more objects to respective data sources associated with the web page.

2. The apparatus of claim 1, further comprising a user interface operable to receive user input to edit the one or more objects.

3. The apparatus of claim 1, wherein the augmented website editor comprises:
one or more Web editor programs arranged to edit the web page copy; and
a translation layer operable to map each one of the one or more objects to a respective data source linked to a Web server containing the web page.

4. The apparatus of claim 1, wherein the augmented website editor is operable to provide in a display:
a website menu having one or more selections corresponding to one or more respective websites; and
a preview field operable to display the web page copy.

5. The apparatus of claim 1, wherein the respective data sources are arranged in XML format.

6. The apparatus of claim 3, wherein the translation layer comprises a translation file that provides one or links that specify location of the respective data sources.

7. The apparatus of claim 3, wherein the translation layer comprises an HTML file that includes one or more attributes, each attribute operable to set a uniform resource locator for a respective data source.

8. The apparatus of claim 4, wherein the preview field is operable to highlight an editable object of the web page copy.

9. The apparatus of claim 8, wherein each editable object is operable to change appearance when an indicating device is placed over the editable object.

10. The apparatus of claim 8, wherein the editable object is defined by an HTML file, the editable object operable to display HTML formatting language when an indicating device is placed over the editable object.

11. The apparatus of claim 1, wherein the augmented website editor is located in multiple user devices.

12. A computer implemented method, comprising:
loading a web page from a Web server into an editor;
receiving input to update a first editable object in the web page; and
mapping the updated first editable object to a corresponding first data source linked to the Web server.

13. The method of claim 12, the mapping comprising:
receiving an indication of the first editable object to be mapped;
locating the corresponding first data source using a translation file; and
updating the corresponding first data source based upon the received input.

14. The method of claim 12, comprising:
receiving input to update a second editable object in the web page;
displaying a copy of the web page including the updated first and second editable objects; and
mapping the updated first and second editable objects to corresponding first and second data sources linked to the Web server.

15. The method of claim 12, comprising storing the received input before mapping the updated first editable object to the corresponding first data source.

16. The method of claim 12 comprising providing an HTML file that includes one or more attributes, each attribute operable to set a uniform resource locator for a corresponding data source linked to the Web server.

17. An article of manufacture comprising a non-transient storage medium containing instructions that when executed enable a system to:
load a web page from a Web server into an editor;
receive input to update a first editable object in the web page; and
map the updated first editable object to a corresponding first data source linked to the Web server.

18. The article of claim 17 containing instructions that when executed enable the system to map the updated first editable object by:
receiving an indication of the first editable object to be mapped;
locating the corresponding first data source using a translation file of the translation layer; and
updating the corresponding first data source based upon the received input.

19. The article of claim 17, containing instructions that when executed enable the system to:
receive input to update a second editable object in the web page;
display a copy of the web page including the updated first and second editable objects; and
map the updated first and second editable objects to corresponding first and second data sources linked to the Web server.

20. The article of claim 17 containing instructions that when executed enable the system to provide an HTML file that includes one or more attributes, each attribute operable to set a uniform resource locator for a corresponding data source linked to the Web server.
